(19) United States
(12) Patent Application Publication
(10) Pub. No.: US 2003/0061206 A1
(43) Pub. Date: Mar. 27, 2003

(54) Personalized content delivery and media consumption

(76) Inventor: Richard Qian, Camas, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/965,224

(22) Filed: Sep. 27, 2001

(51) Int. Cl. G06F 7/00

(52) U.S. Cl. 707/3

(57) ABSTRACT

In one embodiment a personalization engine creates personal preference information from a user regarding a content. The personal preference information is represented in a description compatible with a content analyzer in an edge server. A content scheduler schedules delivery of the content from the edge server and uploading of the personal preference information to the edge server.

In another embodiment, a content analyzer analyzes a content received from a media source based a description compatible with personal preference information from a user regarding the content. The personal preference information is provided by a home server. A content filter filters the content according to the personal preference information for delivery to the user.

### BACKGROUND

1. Field of the Invention

This invention relates to content delivery. In particular, the invention relates to personalized content delivery.

2. Description of Related Art

Advances in network technology have opened up many commercial activities. One useful activity is content delivery. The end user can receive a digital content such as news, movie, audio programs from a service provider via the network or a broadband medium. Edge services are available to speed up the delivery of digital contents by transmitting the contents to the end user via a geographically near-by location.

However, today's edge services are not tailored according to user preferences. Contents are not categorized or organized into categories desired by the end user. The end user often faces with either little relevant contents or too many irrelevant contents.

Therefore, there is a need to have an efficient technique for personalized content delivery and consumption.

### BRIEF DESCRIPTION OF THE DRAWINGS

The features and advantages of the present invention will become apparent from the following detailed description of the present invention in which:

FIG. 1 is a diagram illustrating a system in which one embodiment of the invention can be practiced.

FIG. 2 is a diagram illustrating a home server shown in FIG. 1 according to one embodiment of the invention.

FIG. 3 is a diagram illustrating an edge server shown in FIG. 1 according to one embodiment of the invention.

FIG. 4 is a diagram illustrating a media content according to one embodiment of the invention.

FIG. 5 is a flowchart illustrating a home server process according to one embodiment of the invention.

FIG. 6 is a flowchart illustrating an edge server process according to one embodiment of the invention.

### DESCRIPTION

The present invention is a technique to receive a personalized content from a media source. The delivery of content is efficient and eliminates, reduces, or minimizes the wait time due to insufficient bandwidth. In essence, the technique utilizes a unified infrastructure of network edge servers and local content servers (e.g., home servers). The personalized content is first identified, analyzes, filtered, and assembled at the edge server according to the user's personal preferences. Then, the content is distributed to and cached by the local content server. The local content server is responsible for managing the content and eventually for presenting the content to the user, or distributing further to other personal devices. In this paradigm, the content is pushed to the local edge storage devices, i.e., the so-called “ultimate edge”, prior to consumption time. During consumption or viewing phase, most contents are delivered from the local storage and thus eliminating or reducing the delay caused by low connection speed or network congestion.

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

It is noted that the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a module, a function, a procedure, a subroutine, a subprogram, etc. When a process corresponds to a function, its termination corresponds to a return of the function to the calling function or the main function.

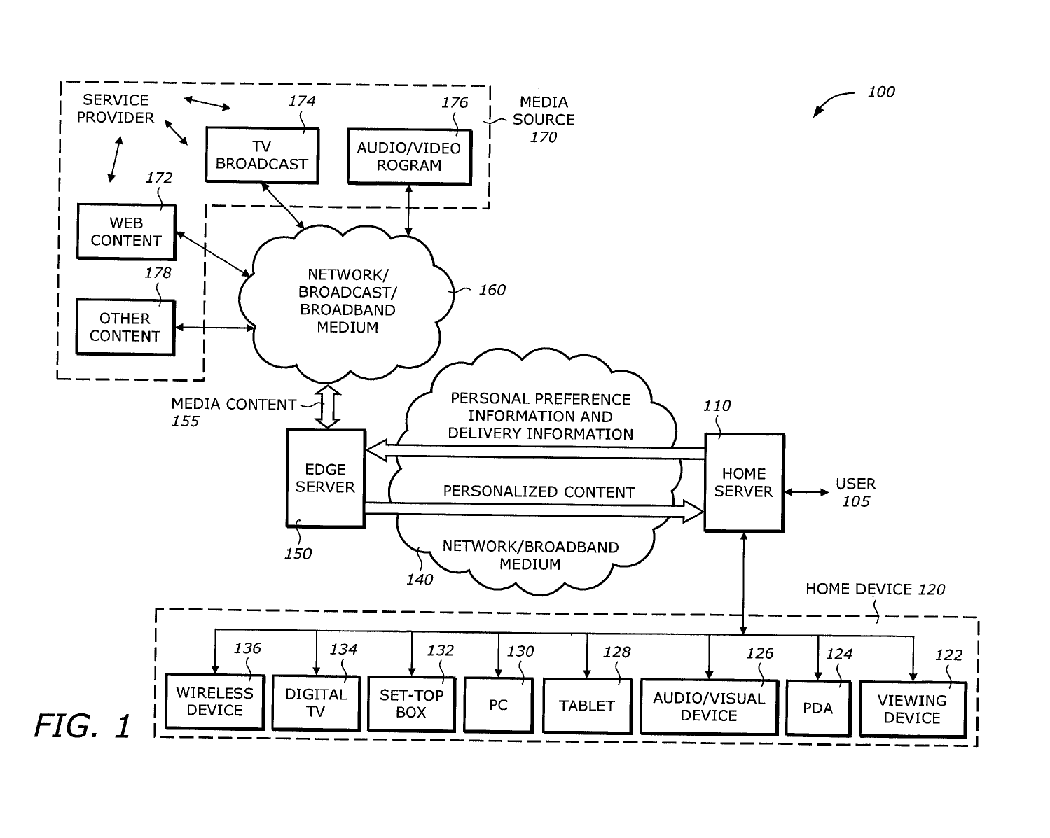

FIG. 1 is a diagram illustrating a system 100 in which one embodiment of the invention can be practiced. The system 100 includes a home server 110, a home device 120, a network/broadband medium 140, an edge server 150, a network/broadcast medium 160, and a media source 170.

The home server 110 provides a user 105 a means to receive media content personalized to the user's preferences or needs. The home server 110 may be located in the user's home or office or any location accessible to the user 105. The home server 110 may be a personal computer (PC) with network interface. The user 105 provides his or her personal preference information either directly, indirectly, or both. The personal preference information may include user's preferences and user's personal information. The user's preferences include contextual preferences regarding the content the user 105 wishes to receive from the media source 170. The preferences may include favorite topics, news, sports news, stock market, movie, music, health, games, and delivery information (e.g., time to download content, quality of service, transmission bandwidth). The user's personal information may include user's personal data such as name, age, address, billing address, payment information (e.g., credit card number, expiration date), subscription level, etc. The user 105 may enter the personal preference information directly. Alternatively, the preferences may be collected and deduced based on user's usage, history of receiving content, past preferences, etc. The user 105 may also provide preferences for content delivery such as time to download, desired quality of service, etc.

The home device 120 is any device that can receive the content stored in the homer server 110 via wired/wireless connections or smart cards. The home device 120 may be any one of a viewing device 122 such as a display monitor, a personal digital assistant (PDA) 124, an audio visual device 126, a tablet 128, a personal computer 130, a set-top box 132, a digital television set 134, a wireless device 136. The wireless device 136 may be a mobile handset, a cell phone, a Bluetooth device, etc. The home device 120 allows the user 105 to view, retrieve, and interact with the personalized content delivered by the edge server 150.

The network/broadband medium 140 provides a transmission means for the home server 140 exchange information with the edge server 150. The network/broadband medium 140 may be a wide area network, a local area network, an Internet, an extranet, an intranet, a cable modem medium, a digital subscriber loop (DSL) connection.

The edge server 150 is a server that is at the edge of the network/broadband medium 160 and 140. Typically the edge server 150 is physically close to the home server 110 or at the edge of the network 140 so that high speed transmission of personalized content can be done. The edge server 150 receives the personal preference information and delivery information from the home server 110 regarding a content the user 105 wishes to receive. The edge server 150 downloads a media content personalized to the user 105 based on the personal preference information at a time and manner provided by the delivery information.

The network/broadcast medium 160 provides a medium or environment to allow the edge server 150 to receive media content 155 from the media source 170. The media source 170 may be any one of a web content 172, a television broadcast program 174, an audio and/or video program 176, or other content 178 (e.g., electronic book, search engine). The media source 170 may be provided by a service provider.

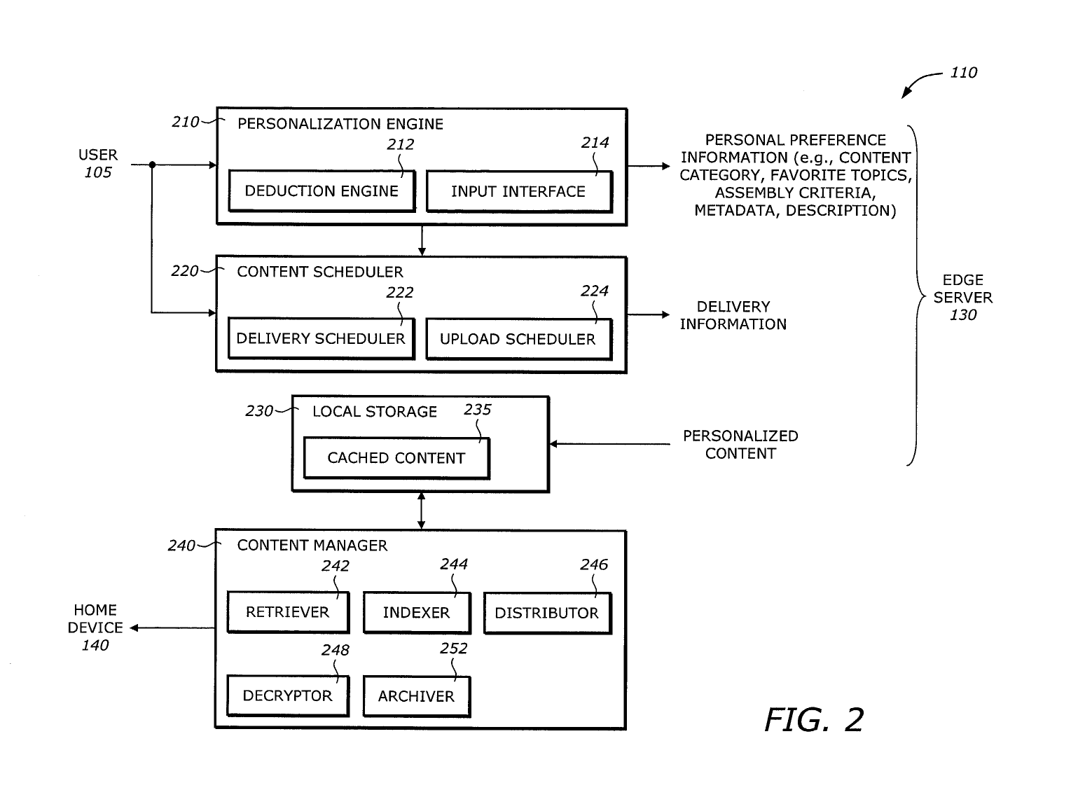

FIG. 2 is a diagram illustrating the home server 110 shown in FIG. 1 according to one embodiment of the invention. The home server 110 includes a personalization engine 210, a content scheduler 220, a local storage 230, and a content manager 240. Any one of the personalization engine 210, the content scheduler 220, the local storage 230, and the content manager 240 may be implemented by hardware, software, or a combination of both.

The personalization engine 210 creates the personal preference information from the user 105 (FIG. 1) regarding a content the user 105 wishes to receive. The personal preference information is represented in a description compatible with a content analyzer in the edge server 150 to be described later. The personal preference information may include the favorite topics or categories, preferred categories of content, delivery information, assembly criteria, descriptors, tags, or metadata. The personalization engine 210 includes a deduction engine 212 and an input interface 214. The deduction engine 212 deduces the personal preference information based on the user's usage or history. The input interface 214 obtains the personal preference information provided directly by the user 105. This may be done by filling out an online questionnaire or answering questions for the user's profile.

The content scheduler 220 receives part of the personal preference information from the personalization engine 210 to schedule several content-related events. The content scheduler 220 includes a delivery scheduler 222 and an upload scheduler 224. The delivery scheduler 222 schedules the delivery of the content from the edge server 150. The upload scheduler schedules the uploading of the personal preference information to the edge server 150. In a typical scenario, the user 105 may want to receive the personalized content at some time later than the time the media content is available for delivery. For example, the user 105 may want to view news regarding a sports program when he or she gets home from work. The user 105 specifies the time, the quality of service, and the transmission bandwidth to receive the personalized content. The scheduler 220 takes this information and transmits to the edge server 150.

The local storage 230 stores or caches the content delivered from the edge server 150 in some form of storage. The local storage 230 may be implemented by any storage device such as a high speed hard disk, flash memories, redundant arrays of inexpensive disks (RAID), or even random access memories (RAMs). The local storage 230 then contains a cached content 235.

The content manager 240 manages the cached content 235. The content manager 240 includes a retriever 242, an indexer 244, a distributor 246, a decryptor 248 and an archiver 252. The retriever 242 retrieves the cache content 235 from the local storage 230. The indexer 244 indexes the cache content according to pre-defined index structure to facilitate the retrieval or access. The distributor 246 distributes the retrieved cache content to the home device 140. The decryptor or decoder 248 decrypts or decodes the cache content using some pre-defined de-cryption or decoding procedure. The archiver 252 archives the cached content for easy accesses.

Since the content is stored and distributed before the user starts a viewing session or before the consumption time, the content can be retrieved or displayed at a much faster rate. In this way, the user can have content ready for viewing without interruptions when he or she views the content while it is being transmitted to the home server 110. The user can enjoy the viewing without waiting periods due to traffic on the net or other problems.

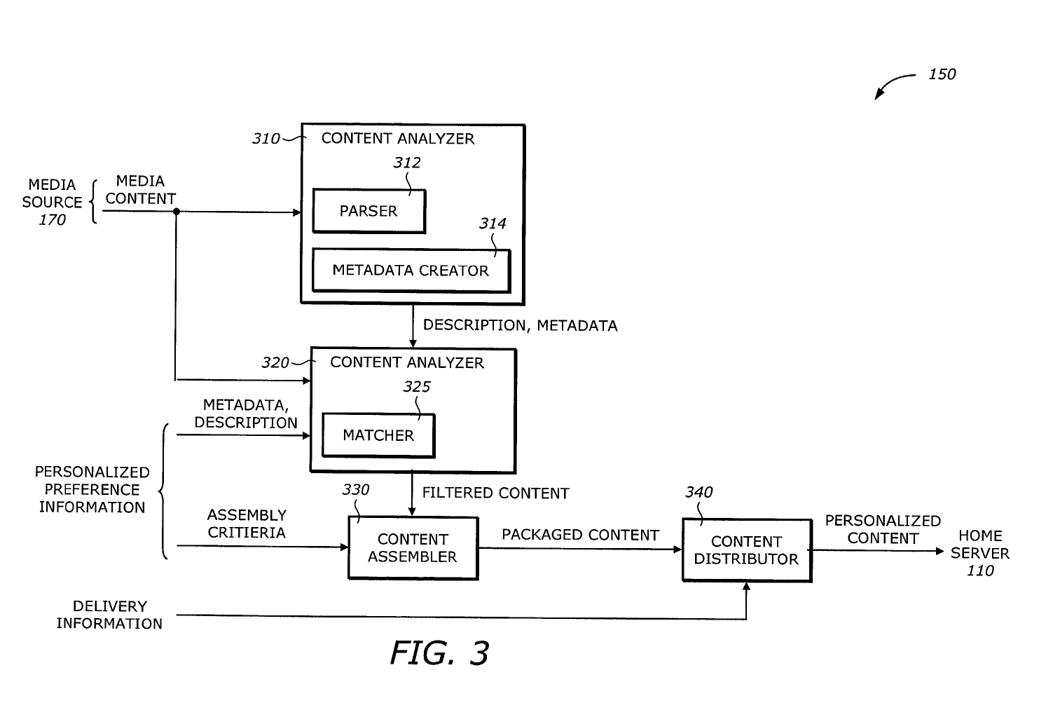

FIG. 3 is a diagram illustrating the edge server 150 shown in FIG. 1 according to one embodiment of the invention. The edge server 150 includes a content analyzer 310, a content filter 320, a content assembler 330, and a content distributor 340.

The content analyzer 310 analyzes the media content received from the media source 170 (FIG. 1) based a description compatible with the personal preference information from the user 105 regarding the content he or she wishes to receive. The personal preference information is provided by a home server 110 as discussed above. The content analyzer 310 includes at least one of a parser 312 and a metadata creator 314. The parser 312 parses the metadata embedded in the content. The metadata creator 314 creates a metadata associated with the content or a descriptor that is compatible with the descriptor or metadata in the personal preference information. When the content does not have or only has insignificant information on a descriptor, tag, or metadata, the metadata creator 314 creates or enhances the descriptor, tag, or metadata associated with the content. Several techniques in pattern recognition, artificial intelligence, and symbolic representation may be employed to extract or create the descriptor, tag, or metadata. These techniques may include text understanding, story understanding, image understanding, speech recognition, neural networks, learning procedures, etc.

The content filter 320 filters the content according to the personal preference information for delivery to the user. The content filter 320 includes a matcher 325 to match the descriptor/tag/metadata of the received media content 155 (FIG. 1) with the descriptor/tag/metadata in the personal preference information. Any content that does not match with the personal preference information is ignored or discarded. Those that satisfy the preference criteria or match with the personal preference information are sent to the content assembler 330. The matching logic may be exact or inexact. Semantic, contextual, fuzzy, and symbolic matching can be employed. For example, for a movie category, the word “star” may be synonymous with “actor” or “actress”. A scoring system may be maintained to rank the results of the matching.

The content assembler 330 assembles the filtered content using the description into a packaged content according to the assembly criteria. The assembly criteria include a semantic topic and a subscription level. The semantic topic is related to the category or contextual information regarding the content. The subscription level refers to the class of service that the user is subscribed for. Since the edge server may filter a large amount of unsolicited media contents, these pieces of contents need to be assembled together.

The content distributor 340 distributes the packaged content to the user based on the delivery information provided by the home server. The content distributor 340 may have interface with the network control system to configures the delivery or downloading accordingly.

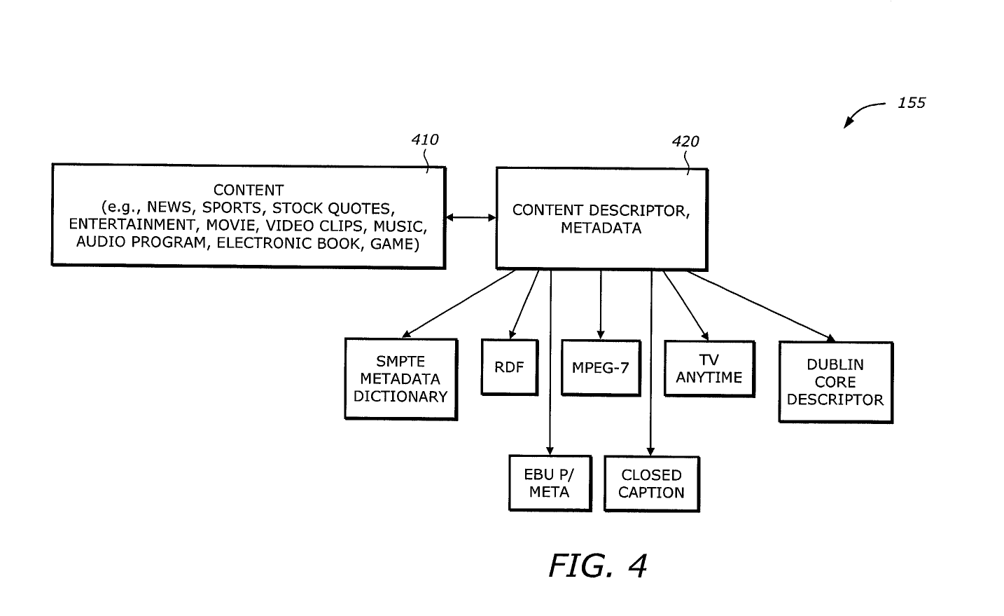

FIG. 4 is a diagram illustrating the media content 155 according to one embodiment of the invention. The media content 155 includes a content 410 and a content descriptor or metadata 420.

The content 410 is any content in any form. Examples of the content include a news article, a sports program, stock quotes, an entertainment event, a movie, a video clips, a music program, an audio program, an electronic book, and a game. The form of the content may be in digital or analog format. The content may be encoded or compressed in any convenient method. In addition, the content may be encrypted or scrambled according to some pre-determined cryptographic standard. When the content is received by the home server, it is then decoded, decompressed, or de-crypted to restore the original content.

The content descriptor or metadata 420 include any information that describes the content in a standardized form. The content descriptor/metadata 420 is typically embedded within the content 410. The content descriptor/metadata 420 may contain: information on the creation and production processes of the content (e.g., title of the content, director, write, author), information related to the usage of the content, information on the storage features of the content (e.g., storage format, encryption, encoding, compression), structural information on spatial, temporal, or spatio-temporal components of the content, information about the low level features of the content (e.g., colors, textures, melody description), etc.

The descriptor/metada 420 may follow some well known standards. Examples of these standards include a closed caption, a Resource Description Framework (RDF), motion picture expert group (MPEG)-7, TV-Anytime metadata, a Society of Motion Picture and Television Engineers (SMPTE) metadata dictionary, a Dublin Core descriptor, and an European Broadcasting Union (EBU) P/meta. The content descriptor/metadata 420 may or may not be available. When the content descriptor/metadata 420 is not available, the edge server 150 may create the metadata or extract the descriptors or features based on techniques employed in pattern recognition, image understanding, speech recognition, neural networks, learning algorithms, etc.

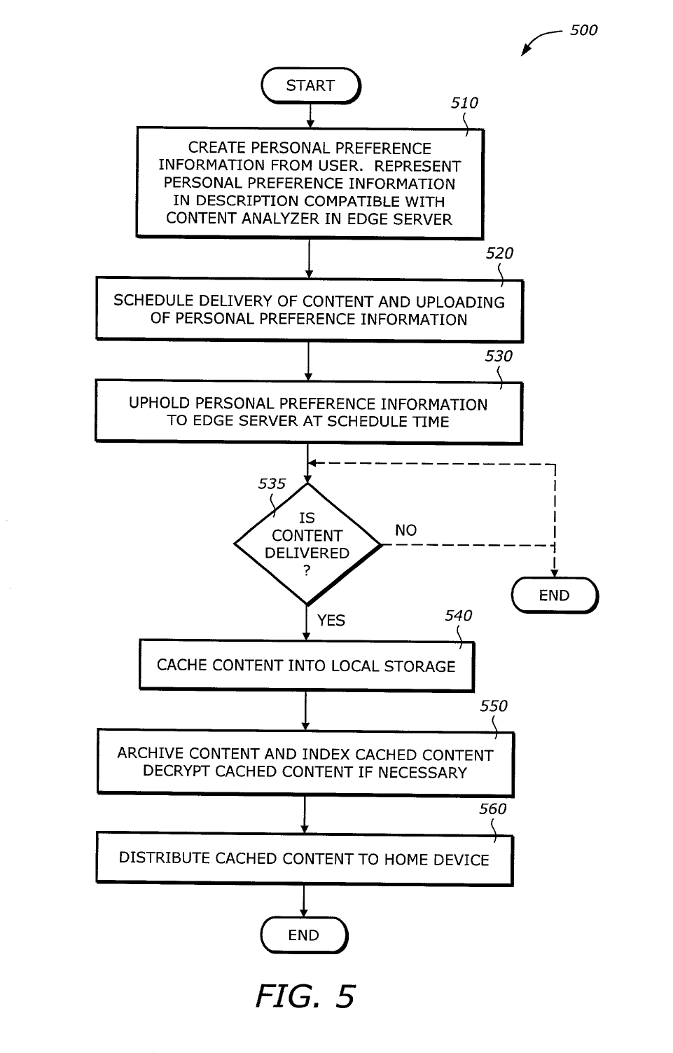

FIG. 5 is a flowchart illustrating a home server process 500 according to one embodiment of the invention.

Upon START, the process 500 creates the personal preference information from the user regarding a content to be delivered (Block 510). Typically, the personal preference information is represented in a description or format compatible with a content analyzer in the edge server. Next, the process 500 schedules the delivery of the personalized content and schedules the uploading of the personal preference information to the edge server (Block 520). Then, the process 500 uploads the personal preference information including the delivery information to the edge server at scheduled time (Block 530).

Next, the process 500 determines if the content has been delivered (Block 535). If not, the process 500 continuously monitors the delivery status. Alternatively, the process 50 may be terminated when the status of the content delivery is notified via some mechanism such as interrupt. If the content has been delivered, the process 500 caches the content into a local storage (Block 540).

Then, the process 500 archives the cache content in some organized fashion. The cached content may also be indexed and de-crypted if necessary (Block 550). Next, the process 500 distributes the cached content to a home device (Block 560) and is then terminated. The distribution of the cached content may take place during the time the user is not available such that when the user becomes available (e.g., going home from work), the cached content has already been distributed and ready to be viewed or retrieved.

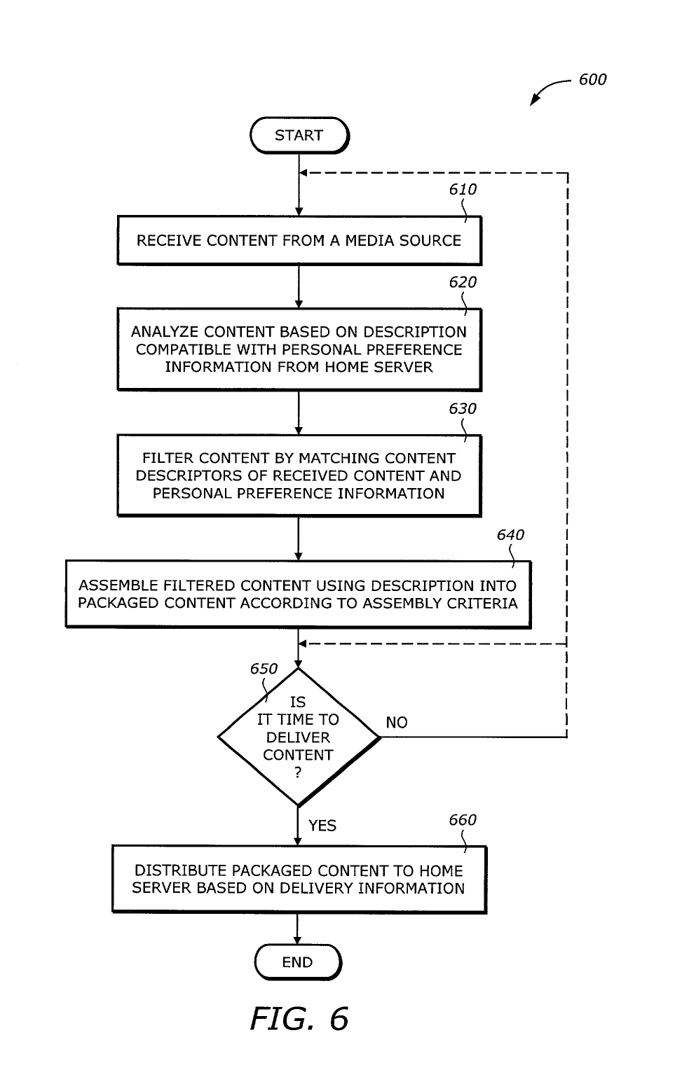

FIG. 6 is a flowchart illustrating an edge server process 600 according to one embodiment of the invention.

Upon START, the process 600 receives a media content from a media source (Block 610). The media content may be downloaded from the media source automatically according to some subscribing activity, or randomly as part of some broadcasting event. Next, the process 600 analyzes the content based on the description compatible with the personal preference information from a home server regarding the content the user wishes to receive (Block 620).

Then, the process 600 filters the media content by matching content descriptors (e.g., metadata) of the received content and the descriptors of the preferred content provided in the personal preference information (Block 630). Any received content that does not match with the personal preference information is discarded or ignored. Next, the process 600 assembles the filtered content, i.e., the content that matches the user's preferences, using the descriptor or description into a packaged content according to assembly criteria (Block 640).

Then, the process 600 determines if it is time to deliver based on the delivery information (Block 650). If not, the process 600 returns back to block 650 or block 610 to continue receiving the next content. If it is time to deliver content, the process 600 distributes the packaged content to the home server based on the delivery information (Block 660) and is then terminated.

The present invention may be implemented by hardware, software, firmware, microcode, or any combination thereof. When implemented in software, firmware, or microcode, the elements of the present invention (e.g., personalization engine, content scheduler, content manager, deduction engine, content analyzer, content filter, content assembler, content distributor, parser, meta-data creator, matcher), are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. The home server and the edge server typically include a mass storage device which provides a mechanism to read machine-readable media.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A home server comprising:
a personalization engine to create personal preference information from a user regarding a content, the personal preference information being represented in a description compatible with a content analyzer in an edge server; and
a content scheduler coupled to the personalization engine to schedule delivery of the content from the edge server and uploading of the personal preference information to the edge server.

2. The home server of claim 1 further comprising:
a local storage to cache the content delivered from the edge server; and
a content manager coupled to the local storage to manage the cached content.

3. The home server of claim 1 wherein the description is compatible with a metadata associated with the content.

4. The home server of claim 3 wherein the metadata is one of a closed caption, a Resource Description Framework (RDF), motion picture expert group (MPEG)-7, TV-Anytime metadata, a Society of Motion Picture and Television Engineers (SMPTE) metadata dictionary, a Dublin Core descriptor, and an European Broadcasting Union (EBU) P/meta.

5. The home server of claim 1 wherein the personalization engine comprises:
a deduction engine to deduce the personal preference information based on user's usage.

6. The home server of claim 1 wherein the personalization engine comprises:
an input interface to obtain the personal preference information provided by the user.

7. The home server of claim 2 wherein the content manager comprises:
a retriever to retrieve the cache content;
an indexer to index the cache content; and
a distributor to distribute the retrieved cache content to a device.

8. The home server of claim 7 wherein the content manager further comprises:
a decryptor to decrypt the cache content; and
an archiver to archive the cached content.

9. The home server of claim 7 wherein the device is one of a viewing device, a personal digital assistant (PDA), an audio visual device, a tablet, a personal computer, a set-top box, a digital television set, and a wireless device.

10. An edge server comprising:
a content analyzer to analyze a content received from a media source based on a description compatible with personal preference information from a user regarding the content, the personal preference information being provided by a home server; and
a content filter coupled to the content analyzer to filter the content according to the personal preference information for delivery to the user.

11. The edge server of claim 10 further comprising:
a content assembler to assemble the filtered content using the description into a packaged content according to an assembly criterion; and
a content distributor coupled to the content assembler to distribute the packaged content to the user based on delivery information provided by the home server.

12. The edge server of claim 10 wherein the media source is one of a Web content, a television broadcast, a media broadcast, a video program, an audio program, and an audio visual program.

13. The edge server of claim 10 wherein the description is compatible with a metadata associated with the content.

14. The edge server of claim 13 wherein the metadata is one of a closed caption, a Resource Description Framework (RDF), motion picture expert group (MPEG)-7, a TV-Anytime metadata, a Society of Motion Picture and Television Engineers (SMPTE) metadata dictionary, a Dublin Core descriptor, and an European Broadcasting Union (EBU) P/meta.

15. The edge server of claim 10 wherein the assembly criterion is one of a semantic topic and a subscription level.

16. The edge server of claim 10 wherein the delivery information includes at least a scheduled time, a quality of service information, and a transmission bandwidth.

17. The edge server of claim 13 wherein the content analyzer comprises:
a parser to parse the metadata.

18. The edge server of claim 10 wherein the content analyzer comprises:
a metadata creator to create a metadata associated with the content.

19. The edge server of claim 10 wherein the content filter comprises:
a matcher to match the description with the personal preference information.

20. A method comprising:
creating personal preference information from a user regarding a content, the personal preference information being represented in a description compatible with a content analyzer in an edge server; and
scheduling delivery of the content from the edge server and uploading of the personal preference information to the edge server.

21. The method of claim 20 further comprising:
caching the content delivered from the edge server; and
managing the cached content.

22. The method of claim 20 wherein the description is compatible with a metadata associated with the content.

23. The method of claim 22 wherein the metadata is one of a closed caption, a Resource Description Framework (RDF), motion picture expert group (MPEG)-7, TV-Anytime metadata, a Society of Motion Picture and Television Engineers (SMPTE) metadata dictionary, a Dublin Core descriptor, and an European Broadcasting Union (EBU) P/meta.

24. The method of claim 20 wherein creating personal preference information comprises:
deducing the personal preference information based on user's usage.

25. The method of claim 20 wherein creating personal preference information comprises:
obtaining the personal preference information provided by the user.

26. The method of claim 21 wherein scheduling delivery comprises:
retrieving the cache content;
indexing the cache content; and
distributing the retrieved cache content to a device.

27. The method of claim 26 wherein scheduling delivery further comprises:
decrypting the cache content; and
archiving the cached content.

28. The method of claim 26 wherein the device is one of a viewing device, a personal digital assistant (PDA), an audio visual device, a tablet, a personal computer, a set-top box, a digital television set, and a wireless device.

29. A method comprising:
analyzing a content received from a media source based on a description compatible with personal preference information from a user regarding the content, the personal preference information being provided by a home server; and
filtering the content according to the personal preference information for delivery to the user.

30. The method of claim 29 further comprising:
assembling the filtered content using the description into a packaged content according to an assembly criterion; and
distributing the packaged content to the user based on delivery information provided by the home server.

31. The method of claim 29 wherein the media source is one of a Web content, a television broadcast, a media broadcast, a video program, an audio program, and an audio visual program.

32. The method of claim 29 wherein the description is compatible with a metadata associated with the content.

33. The method of claim 32 wherein the metadata is one of a closed caption, a Resource Description Framework (RDF), motion picture expert group (MPEG)-7, a TV-Anytime metadata, a Society of Motion Picture and Television Engineers (SMPTE) metadata dictionary, a Dublin Core descriptor, and an European Broadcasting Union (EBU) P/meta.

34. The method of claim 29 wherein the assembly criterion is one of a semantic topic and a subscription level.

35. The method of claim 29 wherein the delivery information includes at least a scheduled time, a quality of service information, and a transmission bandwidth.

36. The method of claim 32 wherein analyzing comprises:
parsing the metadata.

37. The method of claim 29 wherein analyzing comprises:
creating a metadata associated with the content.

38. The method of claim 29 wherein filtering comprises:
matching the description with the personal preference information.

39. A system comprising:
a media source to provide a media content;
an edge server connected to a network; and
a home server coupled to the edge server via the network, the home sever comprising:
a personalization engine to create personal preference information from a user regarding a content, the personal preference information being represented in a description compatible with a content analyzer in the edge server; and
a content scheduler coupled to the personalization engine to schedule delivery of the content from the edge server and uploading of the personal preference information to the edge server.

40. The system of claim 39 further comprising:
a local storage to cache the content delivered from the edge server; and
a content manager coupled to the local storage to manage the cached content.

41. The system of claim 39 wherein the description is compatible with a metadata associated with the content.

42. The system of claim 41 wherein the metadata is one of a closed caption, a Resource Description Framework (RDF), motion picture expert group (MPEG)-7, TV-Anytime metadata, a Society of Motion Picture and Television Engineers (SMPTE) metadata dictionary, a Dublin Core descriptor, and an European Broadcasting Union (EBU) P/meta.

43. The system of claim 39 wherein the personalization engine comprises:
a deduction engine to deduce the personal preference information based on user's usage.

44. The system of claim 39 wherein the personalization engine comprises:
an input interface to obtain the personal preference information provided by the user.

45. The system of claim 40 wherein the content manager comprises:
a retriever to retrieve the cache content;
an indexer to index the cache content;
a distributor to distribute the retrieved cache content to a device.

46. The system of claim 45 wherein the content manager further comprises:
a decryptor to decrypt the cache content; and
an archiver to archive the cached content.

47. The system of claim 45 wherein the device is one of a viewing device, a personal digital assistant (PDA), an audio visual device, a tablet, a personal computer, a set-top box, a digital television set, and a wireless device.

48. A system comprising:
a media source to provide a media content;
a home server connected to a network; and
an edge server coupled to the home server via the network, the edge server comprising:
a content analyzer to analyze a content received from a media source based a description compatible with personal preference information from a user regarding the content, the personal preference information being provided by a home server; and
a content filter coupled to the content analyzer to filter the content according to the personal preference information for delivery to the user.

49. The system of claim 48 further comprising:
a content assembler to assemble the filtered content using the description into a packaged content according to an assembly criterion; and
a content distributor coupled to the content assembler to distribute the packaged content to the user based on delivery information provided by the home server.

50. The system of claim 48 wherein the media source is one of a Web content, a television broadcast, a media broadcast, a video program, an audio program, and an audio visual program.

51. The system of claim 48 wherein the description is compatible with a metadata associated with the content.

52. The system of claim 51 wherein the metadata is one of a closed caption, a Resource Description Framework (RDF), motion picture expert group (MPEG)-7, a TV-Anytime metadata, a Society of Motion Picture and Television Engineers (SMPTE) metadata dictionary, a Dublin Core descriptor, and an European Broadcasting Union (EBU) P/meta.

53. The system of claim 48 wherein the assembly criterion is one of a semantic topic and a subscription level.

54. The system of claim 48 wherein the delivery information includes at least a scheduled time, a quality of service information, and a transmission bandwidth.

55. The system of claim 51 wherein the content analyzer comprises:
a parser to parse the metadata.

56. The system of claim 48 wherein the content analyzer comprises:
a metadata creator to create a metadata associated with the content.

57. The system of claim 48 wherein the content filter comprises:
a matcher to match the description with the personal preference information.
